(19) United States
(12) Patent Application Publication
(10) Pub. No.: US 2010/0043963 A1
(43) Pub. Date: Feb. 25, 2010

(54) ALUMINIUM SHOT FOR THIN, PLATE-SHAPED EFFECT PIGMENTS, METHOD FOR THE PRODUCTION THEREOF, AND USE OF SAME

(76) Inventors: Stefan Trummer, Nurnberg (DE); Marco Greb, Nurnberg (DE); Walter Ziegler, Velden (DE); Klaus Sulek, Waischenfeld (DE); Thomas Schlegl, Simmelsdorf (DE); Martin Schaal, Hohenstadt (DE); Manfred Pleier, Altdorf (DE)

Correspondence Address: OSTROLENK FABER GERB & SOFFEN, 1180 AVENUE OF THE AMERICAS, NEW YORK, NY, 100368403, US

(21) Appl. No.: 12/519,951

(22) PCT Filed: Dec. 21, 2007
(86) PCT No.: PCT/EP07/11348

§ 371 Date: Jun. 18, 2009

(30) Foreign Application Priority Data
Dec. 22, 2006 (DE) 10 2006 062 270.7

(51) Int. Cl. B29C 65/16; B22F 9/08; C22C 21/00; B05D 3/06

(52) U.S. Cl. 156/272.8; 75/338; 420/528; 427/597

(57) ABSTRACT

The invention relates to an atomized aluminum powder for thin, platelet-shaped effect pigments having a narrow relative breadth of the thickness distribution. The powder of the invention is characterized by a particle size band of d₁₀=0.15 to 3.0 μm and d₅₀=0.8 to 5.0 μm and also d₉₀=2.0 to 8.0 μm. The subject matter of the invention relates additionally to a method of producing the atomized aluminum powder of the invention, and to the use of the atomized aluminum powder of the invention as a laser marking agent or laser weldability agent for plastics. The subject matter of the invention relates additionally to the use of the fine atomized aluminum powder for producing ultrathin aluminum pigments by wet milling.

The invention relates to an atomized aluminum powder for producing very thin, platelet-shaped effect pigments having a narrow relative breadth of the thickness distribution. The invention further relates to a method of producing an atomized aluminum powder and to its use as a laser marking agent for transparent plastics materials.

Atomized metal powders have been known for a long time. One of their uses is as a starting material for producing metallic effect pigments.

Atomized aluminum powder is produced by melting high-purity aluminum in melting furnaces, examples being induction furnaces (“atomizers”) at temperatures of about 700° C., and the liquid aluminum melt is finely divided via a suitable nozzle system by means of highly compressed gas or air. The aluminum particles of the atomized aluminum powder are cooled and collected, mixed and homogenized if desired, and classified.

Atomized aluminum powders of this kind are available commercially from, for example, Ecka Granules (D-91235, Velden, Germany).

Depending on the atomization parameters, the atomized aluminum powder in passivated form is an isometric mixture.

The atomized aluminum powder particles have different forms: for example, they may be round, ball-like or ellipsoidal, or nodular. The aluminum content is at least 99.0%.

The milling of the atomized aluminum powder takes place in general by the known Hall wet-milling process in conventional milling units, such as in ball mills, for example, with the aid of grinding media, examples being spherical bodies such as balls, at temperatures of 10° C. to 70° C., with white spirit as a milling medium and with oleic or stearic acid as a milling assistant (lubricant), as a result of which the round aluminum particles are comminuted or formed into platelet-shaped particles, which are also referred to as aluminum flakes. The comminuting or forming agents that are used in the course of milling, and also the lubricant, match the particular intended use of the aluminum pigments.

A multiplicity of chemical compounds are used as lubricants. For a long time, for example, fatty acids having alkyl radicals of 10 to 24 C atoms have been used. Preference is given to the use of stearic acid, oleic acid or mixtures thereof.

The platelet-shaped aluminum pigments or aluminum flakes obtained as products of the milling process may be subjected to size classification and may subsequently be processed conventionally into commercial products and supplied, in accordance with customer requirements, as powders, pastes, granules or pellets.

For example, DE 10 2004 026 955 A1 discloses an atomized aluminum powder, produced by atomizing liquid aluminum, for thin, corrosion-stable, opaque aluminum pigments. The atomized powder particles, with an average diameter below 10 μm, may have a round, ball-like to ellipsoidal or nodular form. This known atomized aluminum powder is used in particular to produce corrosion-stable aluminum pigments having a layer thickness of up to 50 nm and a relative breadth of the thickness distribution of 70%-140%.

Furthermore, DE 103 31 785 A1 relates to a method of producing a fine, ductile metal powder having an average particle diameter D₅₀ of not more than 25 μm. This metal powder is produced from a metal powder comprising spherical or nodular powder particles, by means of a deformation step and a subsequent comminutive milling with milling assistants. This known metal powder is not atomized metal powder relating to the subject matter of the invention.

DE 693 06 789 T2 discloses a metal powder pigment comprising polished pigment particles, preferably substantially finely ground, of aluminum or aluminum alloys, having an average particle size of 1 μm to 300 μm. This known metal powder pigment is produced by comminutive milling of metal such as, for example, aluminum.

DE-A 23 14 874 describes the production of a powder comprising reflective aluminum leaves (aluminum pigments) by milling of a spherulitic powder which can be produced by processes including the atomization process and which has a particle size of 4 to 300 μm. The publication provides no details that characterize this powder more closely.

EP 1 621 586 A1 discloses aluminum effect pigments which are obtained by wet milling and are situated in the thickness range of PVD pigments, with an average thickness of 25 to 80 nm and an average size of 8 to 30 μm. Disadvantageously, however, these pigments do not have the optical properties of PVD pigments.

Finally EP 1 080 810 B1 relates to an aluminum pigment which has been produced by wet milling of aluminum dust. The aluminum dust, which is used, among other things, as an atomization product for pigment production, and which has an average particle size of 2-10 μm, is not described more closely.

EP 1 424 371 A1 discloses aluminum effect pigments obtained by milling aluminum powder. According to the teaching of EP 1 424 371 A1, the aluminum powder employed has an average particle size (D₅₀) in the range from 1 to 10 μm.

Disadvantageously these pigments according to EP 1 621 586 A1, EP 1 080 810 B1 and EP 1424 371 A1 have a very broad relative thickness distribution, a fact which leads to quality detractions in relation to the luster properties of an article printed or coated using these pigments.

It is an object of the invention to provide an atomized aluminum powder for wet milling to platelet-shaped pigments which are intended to have thicknesses and thickness distributions similar to those of PVD aluminum pigments. In comparison to the known atomized aluminum powders, this atomized aluminum powder is to have advantageous properties, particularly with regard to particle size band.

It is a further object of the invention to provide a simple method of producing atomized aluminum powder.

It is a further object to provide a laser marking agent which allows laser markings with high distinctness of image and with very high dot precision even at very fast laser write speeds. The laser marking agent is not to cause any flow lines at all in the plastic or to render such flow lines visible, and is to be of non-toxic materials and nonopacifying.

The object on which the invention is based is achieved through provision of an atomized aluminum powder having a particle size distribution with a d₁₀ of 0.15 to 3.0 μm, a d₅₀ of 0.8 to 5.0 μm, and a d₉₀ of 2.0 to 8.0 μm.

The atomized aluminum powder of the invention is composed therefore of aluminum particles which in toto comply with the aforementioned particle size distribution.

Preferred developments of the atomized aluminum powder of the invention are specified in dependent claims 2 to 4.

The object on which the invention is based is further achieved by a method as claimed in claim 5 of producing an atomized aluminum powder, said method comprising the following steps:

(a) atomizing a liquid aluminum melt, to give aluminum particles,
(b) collecting the aluminum particles obtained in step (a), to give atomized aluminum powder, and
(c) optionally classifying the atomized aluminum powder collected in step (b).

Preferred developments of the method of the invention are specified in dependent claims 6 to 8.

Additional subjects of the invention relate to the use as claimed in claims 9 to 15 of atomized aluminum powder as a laser marking agent or laser weldability agent for plastics.

Atomized aluminum powders for the purposes of the invention are powder grades having an average particle diameter d₅₀ of below 5 μm. Preferably the atomized aluminum powder has an average particle diameter d₅₀ of below 4 μm, more preferably below 3 μm.

The term “particle size distribution” or “particle size band” is used presently to refer to the size distribution of the aluminum particles. The aluminum particles together are referred to as atomized aluminum powder.

The atomized aluminum powder of the invention preferably has a spherical form, preferentially a largely round form. Particular preference is given to powders having a ball-like to slightly ellipsoidal form.

The ratio of the longest to the shortest diameter of the spherical form of an atomized aluminum powder particle is preferably on average 1.2 to 1.0. With a ratio of 1.0 to 1.2, the aluminum particles are approximately ball-shaped or slightly ellipsoidal, which is of great advantage not only for the production of platelet-shaped aluminum pigments, known as aluminum effect pigments, but also for the use as laser marking agents or laser weldability agents.

The production of aluminum effect pigments by deformation treatment from atomized aluminum powder having these size ratios produces aluminum effect pigments having an approximately circular contour and hence quality comparable to aluminum effect pigments particularly with regard to the thickness and low thickness distribution.

When the atomized aluminum powder of the invention is used as a laser marking agent or laser weldability agent, at these size ratios, high distinctness of image and precise weld spots are made possible.

Atomized aluminum powder possesses a particle size distribution which commonly has approximately the form of a log-normal distribution. The size distribution is customarily determined by means of laser granulometry.

With this method, the metal particles can be measured in the form of a powder. The scattering of the irradiated laser light is detected in different spatial directions and evaluated in accordance with the Fraunhofer diffraction theory by means of software (Windox, Version 5, Release 5.1). The particles are treated arithmetically as spheres. Accordingly the diameters determined always refer to the equivalent sphere diameter averaged over all spatial directions, irrespective of the actual form of the metal particles. A determination is made of the size distribution, which is calculated in the form of a volume average (relative to the equivalent sphere diameter). This volume-averaged size distribution can be represented in ways which include that of a cumulative undersize curve. The cumulative undersize curve in turn is usually characterized simplifyingly by means of particular characteristic values, e.g., the d₅₀ or d₉₀.

By a d₉₀ is meant that 90% of all of the particles are situated below the stated value. Expressed alternatively, 10% of all of the particles are situated above the stated value. In the case of a d₅₀, 50% of all the particles are below and 50% of all the particles above the stated value.

The size distribution of the atomized aluminum powder preferably encompasses a d_{powder,10} value of 0.15 to 0.6 μm, a d_{powder,50} value of 0.8 μm to 2.0 μm, and a d_{powder,90} value of 2.0 to 4.0 μm.

Therefore, the atomized aluminum powder having a lower limit of the size distribution with the following characteristic data: d_{powder,10}>0.15 μm, d_{powder,50}>0.8 μm, and d_{powder,90}>2.0 μm, is predominantly not atomized aluminum powder in nanometric dimensions.

The atomized aluminum powder of the invention preferably has an oxygen content of 0.3% to 1.2% by weight and preferentially of 0.4% to 0.8% by weight. The % by weight figure here refers to the total weight of the atomized aluminum powder. It is presumed that the low oxygen content is advantageous in respect of easy deformability and of easy heat transfer to a surrounding plastic. The oxygen content is conditioned by the oxide layer that forms naturally.

For this reason, in addition, the atomized aluminum powder of the invention has a very low oxide content. The aluminum oxide content of the atomized aluminum powder is determined by melting the powder with carbon and determining the resultant carbon monoxide by means of a commercial apparatus (e.g., Omat 3500 from JUWE GmbH). The aluminum oxide content of the atomized aluminum powder is preferably less than 5% by weight, more preferably less than 1.5% by weight, and with particular preference less than 1.0% by weight, based on the powder.

To achieve these low oxide contents, the atomization step, in the form of nozzle atomization, for example, is carried out preferably under an inert gas atmosphere. Inert gases used with preference are nitrogen and/or helium.

The purity of the aluminum used in the nozzle spraying or atomization procedure is preferably 99.0% to more than 99.9% by weight, based on the total weight of the aluminum. The atomized aluminum powder may comprise, in correspondingly small amounts, the typical alloying constituents (e.g., Mg, Si, Fe).

Below a purity of 99.0% by weight, the atomized aluminum powder lacks sufficient ductility to be suitable for producing ultrathin aluminum pigments.

The apparent density of the atomized aluminum powder of the invention is preferably 0.4-0.8 g/cm³.

The atomized aluminum powder is produced preferably in “atomizers” by nozzle spraying of liquid aluminum. This involves the aluminum melt being atomized or sprayed under pressure, preferably using inert gas, and preferably through nozzles, to form aluminum particles. The spherical powder is a very fine atomized aluminum powder having a very narrow size distribution.

The atomized powder, after the atomizing step or nozzle spraying step, can be brought to a desired narrow size distribution by means of corresponding classifying steps. Classifying can be carried out with air classifiers, cyclones, and other known apparatus. As and when necessary, preferably before being classified, the atomized aluminum powder can be mixed and/or homogenized.

Surprisingly it has emerged that, with an atomized aluminum powder having these fineness qualities, and also having a very narrow size distribution, it is possible to produce platelet-shaped aluminum pigments which in terms of their average thicknesses and their thickness distributions are close to those of PVD pigments and yet are substantially more cost-effective to produce.

The platelet-shaped aluminum pigments which can be produced using the atomized aluminum powder of the invention have an average thickness h₅₀ as determined via thickness counting by scanning electron microscopy of 15 to 75 nm, and a relative breadth of the thickness distribution, Δh, which is calculated from the corresponding cumulative undersize curve of the relative frequencies by the formula Δh=100×(h₉₀−h₁₀)/h₅₀, of 30% to less than 70%.

In the case of the average thickness h₅₀, as calculated from the result of the thickness count by scanning electron microscopy (h₅₀ of the cumulative undersize distribution), for the aluminum pigments of the invention, an average thickness h₅₀ of 15 to 75 nm was determined, preferably of 18 to 70 nm, more preferably of 25 to 60 nm, and very preferably of 30 to 55 nm.

Below an average thickness of 15 nm, the pigments become too dark, which is attributable to the loss of metallic reflection capacity with retention of the high absorption properties of the aluminum. Moreover, the mechanical properties of the aluminum are unfavorably altered: the pigments become too fragile. Above an average thickness of 75 nm, the pigments are too thick in comparison to PVD pigments, and the advantageous optical properties are increasingly impaired.

The platelet-shaped aluminum pigments produced from the atomized aluminum powder of the invention preferably have a relative breadth of the thickness distribution, Δh, of 30% to less than 70%, preferentially of 35% to 67%, more preferably of 40% to 65%, and with particular preference of 40% to 60%.

Above a Δh of 70%, the advantageous properties of the aluminum pigments were no longer observable. In particular it was no longer possible to ascertain the high luster, comparable with that of PVD pigments, of what are referred to as “reverse-side applications”. Furthermore, these pigments with a Δh of more than 70% sometimes exhibit problems in transfer behavior in printing. Pigments having a relative breadth of the thickness distribution, Δh, of below 30% were hitherto unproducible.

During the deformation milling, the atomized aluminum powder particles are not deformed with complete uniformity; instead, certain particles are more greatly deformed, whereas some of the powder particles are deformed only at a very late stage during the milling operation. One of the reasons for this is the fact that the deformation probability of a particle is dependent on its size. Thus particles which have already been pre-deformed to give platelets have a higher specific surface area than as yet undeformed atomized powder, and, accordingly, have a greater probability of being further deformed. Consequently the breadth of the size distribution of the atomized powder enters not only into the size distribution of the aluminum platelets formed from it, but also into the distribution of the thickness distribution. For narrow thickness distributions, therefore, it is necessary to use an atomized aluminum powder with a correspondingly low size variance.

The d₅₀ values of the length distribution of the pigments are preferably above 3 μm, more preferably in a range from 4 μm to 50 μm, preferably from 5 μm to 45 μm, more preferably from 8 μm to 40 μm, more preferably from 10 μm to 30 μm, more preferably still from 15 μm to 25 μm.

Preference is given, furthermore, to fine pigments in a size range with a length of 3 to 15 μm and more preferably 5 to 12 μm. Such pigments, moreover, have preferably nonleafing properties. They are milled, for example, with oleic acid as lubricant, and are therefore coated with this substance. Pigments of this kind are suitable in particular for what are called reverse-side applications in the printing sector.

With a reverse-side application, a transparent film is printed with a printing ink comprising PVD pigments. When the film is viewed through the unprinted reverse side after the printing ink has cured, a metallic luster is perceived which is a near match to that of a mirror. Preferred uses for this form of application are in headlamp panels.

In the case of printing inks, the binder fractions and the layer thicknesses are generally very much lower than in paints. This is so in particular for gravure inks. Gravure inks pigmented with conventional aluminum pigments have a solids content of around 40% by weight. Print films of these inks have a wet-film layer thickness of around 3 to 6 μm and a dry-film layer thickness of around 1.5 to 3 μm. In the case of gravure inks pigmented with PVD pigments, the solids fractions are around 15% to 20% by weight of the overall gravure ink. The accompanying dry-film layer thicknesses are therefore preferably only 0.5 to 1.5 μm. At these extremely low layer thicknesses, especially in the case of reverse-side application, a largely uniform, plane-parallel orientation of the metal pigments is necessary. This was hitherto achievable only by means of PVD pigments. The platelet-shaped metal pigments produced by means of the atomized aluminum powder of the invention, by wet milling, have a similar average particle thickness and also a similar particle-thickness distribution. Only pigments of this kind, which were hitherto unobtainable, are able to exhibit an optical effect comparable with that of PVD pigments in reverse-side application.

With these metal pigments virtually no differences in optical quality are found in gravure applications with respect to PVD pigments.

The atomized aluminum powder of the invention is milled using a milling mechanism, preferably a ball mill, with or without a stirring mechanism, in the presence of solvent and lubricants as milling assistants and of grinding media which have an individual weight of 1.2 to 13 mg. On account of the extremely gentle mode of milling, this milling operation lasts a comparatively long time. The milling time is preferably 15 to 100 h and more preferably 16 to 80 h.

In accordance with one preferred development of the invention, the grinding media have an individual weight of 2.0 to 12.5 mg and more preferably of 5.0 to 12.0 mg. Grinding media used are preferably spherical bodies, more preferably balls.

Preferred balls are those having a very smooth surface, a very round shape, and a largely uniform size. The ball material may be of steel, glass or ceramic, such as zirconium oxide or corundum, for example. The temperatures during the milling operation are situated in the range from 10° C. to 70° C. Temperatures in a range from 25° C. to 45° C. are preferred.

Particular preference is given to balls made of glass and having an average individual weight of 2.0 to 12.5 mg.

Milling may take place in a solvent, with a weight ratio of solvent to aluminum particle of 2.8 to 10 and with a weight ratio of grinding balls to aluminum particles of 20-120, and with lubricants as milling assistants.

The long milling times lead to a large number of pigment-ball collisions. As a result of this the pigment is very uniformly shaped, forming a very smooth surface and a very narrow thickness distribution.

In relation to milling in a ball mill, the critical speed n_{crit} is an important parameter, which indicates the point from which the balls are pressed by the centrifugal forces against the wall of the mill, and there is virtually no longer any milling:

$${n}_{crit} = \sqrt{\frac{g}{2 {π}^{2}} \cdot \frac{1}{D}}$$

where D is the drum diameter
and g is the gravitational constant.

The rotational speeds of the ball mill are preferably 25% to 68%, more preferably 28% to 60%, and with particular preference 30% to below 50%, and additionally with particular preference 35% to 45% of the critical speed n_{crit}.

Low rotational speeds promote slow deformation of the aluminum particles. In order to bring about slow deformation, lightweight grinding balls as well are used with preference in the method of the invention.

Grinding balls having an individual weight of more than 13 mg cause excessive deformation of the aluminum particles, leading to premature fracture. As aluminum particles it is preferred to use atomized aluminum powder.

In the case of the present method, in contrast to conventional milling methods, the majority fraction of the aluminum particles are not ground down or comminuted, but instead are deformed extremely gently over a prolonged time period.

The conditions recited above result in very gentle milling, in the course of which the aluminum particles are slowly shaped and fractures due to ball impact with high kinetic energy are avoided.

There are a multiplicity of compounds that can be used as lubricants in the course of milling.

They include the fatty acids with alkyl radicals of 10 to 24 C atoms that have been used for a considerable time. Preference is given to using stearic acid, oleic acid or mixtures thereof. Stearic acid as a lubricant leads to leafing pigments, while oleic acid leads to nonleafing pigments.

Leafing pigments are characterized in that they float in an application medium, such as a paint or a printing ink, for example, i.e., they adopt an ordered position at the surface of the application medium.

Nonleafing pigments, in contrast, adopt an ordered position within the application medium.

Additionally it is possible for long-chain amino compounds, for example, to be added to the fatty acids. The fatty acids may be animal or plant in origin. It is likewise possible to use organic phosphonic acids and/or phosphoric esters as lubricants.

The amount of the lubricant used should not be too low, since otherwise, as a consequence of the great deformation of the aluminum particles, the very large surface areas of the platelet-like aluminum pigments produced are not satisfactorily occupied by adsorbed lubricant. In that case there may be instances of cold welding. Typical amounts are therefore 1% to 20% by weight, preferably 2% to 15% by weight, of lubricant relative to the weight of aluminum used.

The choice of the solvent is not critical per se. Customary solvents such as white spirit, solvent naphtha, etc., can be used. Also possible is the use of alcohols, such as isopropanol, ethers, ketones, esters, and so on.

As a result of the production method, these aluminum pigments, very advantageously indeed, are free from adhering polymer films. Therefore these pigments do not possess the disadvantages of aluminum pigments produced by PVD processes that are hampered by residues of the release coat. Furthermore, their mode of production is cheaper than in the case of the costly and inconvenient PVD production. The aluminum pigments produced can be separated from the grinding media, preferably grinding balls, in a conventional way by sieving.

After the milling of the aluminum particles, the aluminum pigments obtained are separated from the grinding media, preferably the grinding balls.

In a further step of the method, the aluminum pigments obtained can be subjected to a size classification process. This process ought to be carried out gently, so as not to destroy the thin aluminum pigments. This process may involve, for example, wet sieving, decanting or else separation by sedimentation (on the basis of gravity or by centrifuging).

In the case of wet sieving it is generally the coarse fraction which is screened out.

With the other processes it is possible in particular to separate off the ultrafine fraction.

Subsequently the suspension can be separated from excess solvent, with the aid, for example, of a filter press, centrifuge or filter.

In the last step, the product is subjected to further processing to give the desired presentation form.

Although the metal pigments produced with the atomized aluminum powder of the invention have—in comparison to PVD pigments—a similar thickness and a similar thickness distribution, these pigments, surprisingly, are much easier to handle. Advantageously, these aluminum pigments are not confined in their presentation forms to the low-concentration dispersion form that is customary in the case of PVD pigments.

Thus it is possible, as with conventional aluminum pigments, to select the paste form. The solids content in this case is 30% to 65%, preferably 40% to 60%, and more preferably 45% to 55%, by weight, based on the total weight of the paste.

Furthermore, these aluminum pigments can be converted by drying into a powder form, preferably a nondusting powder form. The dried powder can be processed further in a suitable homogenizer to give a nondusting metal powder, by addition of very small amounts of solvent—for example, <10% by weight or less than 5% by weight. It is also possible first to dry the filter cake and then to paste it up again with a different solvent, this also being referred to as rewetting.

The aluminum pigments produced with the atomized aluminum powder of the invention find use in coatings, paints, printing inks, powder coating materials, plastics, and cosmetic formulations.

Moreover it has emerged, surprisingly, that the ultrafine atomized aluminum powder of the invention can be used with particular advantage as a laser marking agent for transparent plastics materials. The laser marking agents composed of the atomized aluminum powder of the invention allow marking of transparent plastics materials with good contrast and high dot precision in conjunction with streak-free incorporation. Preferably the intention is to obtain a good contrast without necessarily having to color the plastics materials. Moreover, laser marking agents comprising atomized aluminum powder are toxicologically unobjectionable, are also inexpensive, and are available to the market in large quantities. These laser marking agents permit extremely distinct images marked with high dot precision following irradiation of laser light.

It is thought that, through the use of the extremely fine atomized aluminum powder of the invention, on the basis of its high specific surface area, the absorption of laser light and, subsequently, the delivery of energy to the vicinity of the metal powder take place in a particularly defined, locally narrowly confined way. Consequently the laser marks on correspondingly pigmented plastics exhibit the stated advantages.

With the very fine atomized aluminum powder of the invention it has surprisingly been found that laser markings of high contrast and dot precision can be obtained at very high laser write speeds. The write speeds of the laser range from 120 to about 10 000 mm/s, preferably from 150 to 8000 m/s, more preferably from 200 to 2000 m/s, and very preferably from 230 to 1000 m/s. The write speed that is achievable in each specific case is dependent here on a large number of parameters, but particularly on the laser power and the pulse frequency. This brings considerable time advantages with it in respect of the throughput rates in the laser marking of objects.

Following irradiation of a laser beam into a plastic which comprises the atomized aluminum powder of the invention there is, following irradiation of a laser beam, selective heating of the microscale aluminum particles, transfer of the heat to the surrounding plastic, and, as a result of thermally induced polymer breakdown, the attendant carbonization and/or the attendant foaming of the polymers surrounding the aluminum particles in the plastics matrix. Carbonization and/or foaming occurs depending on the nature of the polymer used and/or depending on the energy input by the laser beam.

Carbonization leads to blackening; foaming leads to a lightening in color, which can extend as far as up to a kind of whitening. In the majority of cases the desire is for a distinct contrast to the unmarked plastic.

In further embodiments, however, the change in the plastic that is brought about by the thermally induced polymer breakdown may be so small that it cannot be perceived, or not significantly, with the human eye. Marks of this kind can, however, be detected by special read devices. Accordingly such substantially invisible laser markings may find use, for example, for security markings or for inscribing CDs.

Since the carbonization and/or foaming takes place only locally around the microscale aluminum particles, marking can be carried out with high dot precision. A high distinctness of image is manifested by phenomena which include a line being perceived not as a collection of individual dots but instead as a continuous straight line, which is composed of a multiplicity of small dots that the human eye is unable to resolve.

It has therefore emerged as being extremely surprising that—although the interaction of the atomized aluminum powder with visible light is not strong enough to cause graying or clouding of a plastics material—the interaction with irradiated laser light is nevertheless sufficient to generate the desired carbonization and/or the desired foaming of the polymer matrix surrounding the aluminum particles and hence to provide the plastics article with a high-contrast identification or marking.

On account of their very high absorption capacities for electromagnetic radiation from the UV through to the IR range, and also on account of their excellent thermal conductivity, the aluminum particles in the microscale atomized aluminum powder of the invention are especially suitable as laser marking agents and/or laser weldability agents. Their efficacy in these respects exceeds that of conventional metal-oxide particles.

The laser-markable plastic preferably comprises thermoplastic, thermoset or elastomeric plastics. Particular preference here is given to thermoplastics.

Suitable thermoplastic polymers include all of the thermoplastics that are known to a person skilled in the art. Suitable thermoplastic polymers are described in, for example, Kunststoff-Taschenbuch, Saechtling (Ed.), 25th edition, Hanser-Verlag, Munich, 1992, especially chapter 4 and references cited therein, and in Kunststoff-Handbuch, G. Becker and D. Braun (Eds.), volumes 1 to 11, Hanser-Verlag, Munich, 1966 to 1996.

Exemplary mention may be made as suitable thermoplastics of polyoxyalkylenes, polycarbonates (PC), polyesters such as polybutylene terephthalate (PBT) or polyethylene terephthalate (PET), polyolefins such as polyethylene or polypropylene (PP) poly(meth)acrylates, polyamides, vinylaromatic (co)polymers such as polystyrene, impact-modified polystyrene such as HI-PS, or ASA, ABS or AES polymers, polyarylene ethers such as polyphenylene ethers (PPE) polysulfones, polyurethanes, polylactides, halogen-containing polymers, polymers containing imide groups, cellulose esters, silicone polymers, and thermoplastic elastomers. Mixtures of different thermoplastics can also be used as materials for the plastics moldings. These mixtures may be single-phase or multiphase polymer blends.

The plastics to be inscribed or to be joined to one another may consist of identical or different thermoplastics and/or thermoplastic blends.

Polyoxyalkylene homopolymers or copolymers, especially (co)polyoxymethylenes (POM), and processes for preparing them are known per se to a person skilled in the art and are described in the literature. Suitable materials are available commercially under the brand name Ultraform® (BASF AG, Germany). Very generally these polymers contain at least 50 mol % of repeating —CH₂O— units in the main polymer chain. The homopolymers are generally prepared by polymerizing formaldehyde or trioxane, preferably in the presence of suitable catalysts. Polyoxymethylene copolymers and polyoxymethylene terpolymers are preferred. The preferred polyoxymethylene (co)polymers have melting points of at least 150° C. and molecular weights (weight average) M in the range from 5000 to 200 000, preferably from 7000 to 150 000 g/mol. Endgroup-stabilized polyoxymethylene polymers which have C—C bonds at the chain ends are particularly preferred.

Suitable polycarbonates are known per se and are obtainable, for example, in accordance with DE-B-1 300 266 by interfacial polycondensation or in accordance with DE-A-14 95 730 by reaction of biphenyl carbonate with bisphenols. A preferred bisphenol is 2,2-di(4-hydroxyphenyl)propane, referred to generally as bisphenol A. The relative viscosity of these polycarbonates is situated in general in the range from 1.1 to 1.5, in particular from 1.28 to 1.4 (measured at 25° C. in a 0.5% strength by weight solution in dichloromethane). Suitable polycarbonates are available commercially under the brand name Lexan® (GE Plastics, B.V., the Netherlands).

Suitable polyesters are likewise known per se and described in the literature. In their main chain they contain an aromatic ring which originates from an aromatic dicarboxylic acid. The aromatic ring may also be substituted, as for example by halogen such as chlorine and bromine or by C₁-C₄ alkyl groups such as methyl, ethyl, isopropyl and n-propyl, and n-butyl, isobutyl and/or tert-butyl groups. The polyesters can be prepared by reacting aromatic dicarboxylic acids, their esters or other ester-forming derivatives thereof with aliphatic dihydroxy compounds in a manner known per se. Preferred dicarboxylic acids include naphthalenedicarboxylic acid, terephthalic acid, and isophthalic acid or mixtures thereof. Up to 10 mol % of the aromatic dicarboxylic acids may be replaced by aliphatic or cycloaliphatic dicarboxylic acids such as adipic acid, azelaic acid, sebacic acid, dodecanedioic acids, and cyclohexanedicarboxylic acids. Preference among the aliphatic dihydroxy compounds is given to diols having 2 to 6 carbon atoms, especially 1,2-ethanediol, 1,4-butanediol, 1,6-hexanediol, 1,4-hexanediol, 1,4-cyclohexanediol, and neopentyl glycol or mixtures thereof. Particularly preferred polyesters include polyalkylene terephthalates which derive from alkanediols having 2 to 6 C atoms. Of these, particular preference is given to polyethylene terephthalate (PET), polyethylene naphthalate, and polybutylene terephthalate (PBT). These products are available commercially, for example, under the brand names Rynite® (PET; DuPont, USA) and Ultradur® (PBT; BASF AG). The viscosity number of the polyesters is situated generally in the range from 60 to 200 ml/g (measured in a 0.5% strength by weight solution in a phenol/o-dichlorobenzene mixture (weight ratio 1:1 at 25° C.)).

Suitable polyolefins are, very generally, polyethylene and polypropylene and also copolymers based on ethylene or propylene, where appropriate also with higher α-olefins. Corresponding products are available, for example, under the trade names Lupolen® and Novolen®. The term “polyolefins” should also be taken to include ethylene-propylene elastomers and ethylene-propylene terpolymers.

Among the poly(meth)acrylates, mention may be made in particular of polymethyl methacrylate (PMMA) and also copolymers based on methyl methacrylate with up to 40% by weight of further copolymerizable monomers, such as n-butyl acrylate, tert-butyl acrylate or 2-ethylhexyl acrylate, such polymers being obtainable, for example, under the names Lucryl® (BASF AG) or Plexiglas® (Röhm GmbH, Germany). For the purposes of the invention, these also include impact-modified poly(meth)acrylates and also mixtures of poly(meth)acrylates and SAN polymers which have been impact-modified with polyacrylate rubbers (an example being the commercial product Terlux® from BASF AG).

Suitable polyamides are those with an aliphatic, partially crystalline or partially aromatic or amorphous construction, of any kind, and their blends, including polyetheramides such as polyether-block-amides. By polyamides are meant all known polyamides. Suitable polyamides generally have a viscosity number of 90 to 350 ml/g, preferably 110 to 240 ml/g (determined in a 0.5% strength by weight solution in 96% strength by weight sulfuric acid at 25° C. in accordance with ISO 307). Semicrystalline or amorphous resins with a molecular weight (weight average) of at least 5000 g/mol, of the kind described, for example, in U.S. Pat. Nos. 2,071,250, 2,071,251, 2,130,523, 2,130,948, 2,241,322, 2,312,966, 2,512,606, and 3,393,210, are preferred.

Examples thereof are polyamides which derive from lactams having 7 to 13 ring members, such as polycaprolactam, polycapryllactam, and polylauryl-lactam, and also polyamides which are obtained by reacting dicarboxylic acids with diamines.

Dicarboxylic acids which can be used are alkane-dicarboxylic acids having 6 to 12, more particularly 6 to 10, carbon atoms, and aromatic dicarboxylic acids. Mention may be made here of adipic acid, azelaic acid, sebacic acid, dodecanedioic acid (i.e., decane-dicarboxylic acid) and/or isophthalic acid as acids.

Particularly suitable diamines are alkanediamines having 6 to 12, more particularly 6 to 8, carbon atoms and also m-xylylenediamine, di(4-aminophenyl)methane, di(4-aminocyclohexyl)methane, 2,2-di(4-aminophenyl)-propane or 2,2-di(4-aminocyclohexyl)propane.

Preferred polyamides are polyhexamethyleneadipamide (PA66), e.g., the commercial product Ultramid® A (BASF AG), and polyhexamethylenesebacamide (PA 610), e.g., the commercial product Nylon® 610 (DuPont), poly-caprolactam (PA 6), e.g., the commercial product Ultramid® B (BASF AG), and also copolyamides 6/66, in particular with a fraction of 5% to 95% by weight of caprolactam units, e.g., the commercial product Ultramid® C (BASF AG). PA 6, PA 66, and copolyamides 6/66 are particularly preferred.

Mention may also be made, moreover, of polyamides which are obtainable, for example, by condensation of 1,4-diaminobutane with adipic acid at elevated temperature (polyamide-4,6). Preparation processes for polyamides of this structure are described in, for example, EP-A 38 094, EPA 38 582, and EP-A 39 524. Further examples are polyamides which are obtainable by copolymerizing two or more of the aforementioned monomers, or mixtures of two or more polyamides, the mixing ratio being arbitrary.

Moreover, partially aromatic copolyamides of this kind, such as PA 6/6T and PA 66/6T with a triamine content of less than 0.5%, preferably less than 0.3%, by weight (see EP-A 299 444) have proven particularly advantageous. The preparation of the low-triamine-content partially aromatic copolyamides may be accomplished in accordance with the processes described in EP-A 129 195 and 129 196.

Further suitable thermoplastic materials are vinylaromatic (co)polymers. The molecular weight of these polymers, which are known per se and are available commercially, is situated in general in the range from 1500 to 2 000 000, preferably in the range from 70 000 to 1 000 000 g/mol.

Merely by way of representation, mention may be made here of vinylaromatic (co)polymers of styrene, chlorostyrene, α-methylstyrene, and p-methylstyrene; in minor proportions, preferably not more than 20%, in particular not more than 8%, by weight, comonomers such as (meth)acrylonitrile or (meth)acrylic esters may also be involved in the construction. Particularly preferred vinylaromatic (co)monomers are polystyrene, styrene-acrylonitrile (SAN) copolymers, and impact-modified polystyrene (HIPS=high impact polystyrene). It is understood that mixtures of these polymers as well can be used. Preparation takes place preferably by the process described in EP-A-302 485.

Furthermore, ASA, ABS, and AES polymers (ASA=acrylonitrile-styrene-acrylic ester, ABS=acrylonitrile-butadiene-styrene, AES=acrylonitrile-EPDM rubber-styrene) are particularly preferred. These impact-tough, vinylaromatic polymers comprise at least one rubber-elastic graft polymer and a thermoplastic polymer (matrix polymer). Matrix material commonly employed is a styrene/acrylonitrile (SAN) polymer. It is preferred to use graft polymers which comprise as their rubber
a diene rubber based on dienes, such as butadiene or isoprene, for example, (ABS);
an alkyl acrylate rubber based on alkyl esters of acrylic acid, such as n-butyl acrylate and 2-ethylhexyl acrylate, (ASA);
an EPDM rubber based on ethylene, propylene and a diene, (AES);
   or mixtures of these rubbers and/or rubber monomers.

The preparation of suitable ABS polymers is described in depth in—for example—German patent application DE-A 19728629. For the preparation of ASA polymers, recourse may be made, for example, to EP-A 99 532. Details of the preparation of AES polymers are disclosed in, for example, U.S. Pat. No. 3,055,859 or U.S. Pat. No. 4,224,419. Reference is hereby made expressly to the patent specifications cited in this paragraph.

Polyarylene ethers are preferably polyarylene ethers per se, polyarylene ether sulfides, polyarylene ether sulfones or polyarylene ether ketones. Their arylene groups may be alike or different and independently of one another may denote an aromatic radical having 6 to 18 C atoms. Examples of suitable arylene radicals are phenylene, bisphenylene, terphenylene, 1,5-naphthylene, 1,6-naphthylene, 1,5-anthrylene, 9,10-anthrylene or 2,6-anthrylene. Of these, preference is given to 1,4-phenylene and 4,4′-biphenylene. Preferably these aromatic radicals are not substituted. However, they may carry one or more substituents. Suitable polyphenylene ethers are available commercially under the Noryl® designation (GE Plastics B.V., the Netherlands).

In general the polyarylene ethers have average molecular weights M (number average) in the range from 10 000 to 60 000 g/mol and viscosity numbers of 30 to 150 ml/g. Depending on the solubility of the polyarylene ethers, the viscosity numbers are measured either in 1% strength by weight N-methylpyrrolidone solution, in mixtures of phenol and o-dichlorobenzene, or in 96% strength sulfuric acid, in each case at 20° C. or 25° C.

The polyarylene ethers are known per se or can be prepared by methods that are known per se.

Preferred process conditions for the synthesis of polyarylene ether sulfones or polyarylene ether ketones are described in, for example, EP-A 113 112 and EP-A 135 130. Polarylene ether sulfones generally have a melting point of at least 320° C., polyarylene ether ketones one of at least 370° C. Suitable polyphenylene ether sulfones are available commercially, for example, under the Ultrason® E designation (BASF AG), suitable polyphenylene ether ketones under the Victrex® designation.

Furthermore, polyurethanes, polyisocyanurates, and polyureas are suitable materials for producing laser-markable plastics moldings using the atomized aluminium powder of the invention. Soft, half-hard or hard, thermoplastic or crosslinked polyisocyanate polyaddition products, examples being polyurethanes, polyisocyanurates and/or polyureas, especially polyurethanes, are general knowledge and are available commercially under designations including that of Elastolan® (Elastogran GmbH, Germany). Their preparation is diversely described and is typically accomplished by reaction of isocyanates with isocyanate-reactive compounds under conditions which are general knowledge. The reaction is carried out preferably in the presence of catalysts and/or auxiliaries. When the products are foamed polyisocyanate polyaddition products, they are produced in the presence of customary blowing agents.

Suitable isocyanates include the aromatic, arylaliphatic, aliphatic and/or cycloaliphatic organic isocyanates that are known per se, preferably diisocyanates.

Isocyanate-reactive compounds which can be used include, for example, common-knowledge compounds having a molecular weight of 60 to 10 000 g/mol and a functionality with respect to isocyanates of 1 to 8, preferably 2 to 6 (in the case of thermoplastic polyurethanes, TPU, a functionality of about 2) examples being polyols having a molecular weight of 500 to 10 000 g/mol, e.g., polyether polyols, polyester polyols, polyether polyester polyols, and/or diols, triols and/or polyols having molecular weights of less than 500 g/mol.

Polylactides, in other words polymers of lactic acid, are known per se or can be prepared by processes that are known per se, and can likewise be used in laser-markable form in conjunction with the atomized aluminum powder of the invention. Besides polylactide it is also possible to use copolymers or block copolymers based on lactic acid and further monomers. Usually linear polylactides are used. However, branched lactic acid polymers can be used as well. Serving as branching agents may be, for example, polyfunctional acids or alcohols.

Suitable halogen-containing polymers include, in particular, polymers of vinyl chloride, especially polyvinyl chloride (PVC) such as unplasticized PVC and plasticized PVC, and copolymers of vinyl chloride such as PVC-U molding compounds.

Additionally suitable are fluorine-containing polymers, especially polytetrafluoroethylene (PTFE), tetrafluoro-ethylene-perfluoropropylene copolymers (FEP), copolymers of tetrafluoroethylene with perfluoroalkyl vinyl ether, ethylene-tetrafluoroethylene copolymers (ETFE), polyvinylidene fluoride (PVDF), polyvinyl fluoride (PVF), polychlorotrifluoroethylene (PCTFE), and ethylene-chlorotrifluoroethylene copolymers (ECTFE).

Polymers containing imide groups are, in particular, polyimides, polyetherimides, and polyamideimides.

Suitable cellulose esters are for instance cellulose acetate, cellulose acetobutyrate, and cellulose propionate.

Also suitable in addition as thermoplastics are silicone polymers. Silicone rubbers in particular are suitable. These are customarily polyorganosiloxanes which have groups capable of crosslinking reactions. Polymers of this kind are described in, for example, Römpp Chemie Lexikon, CD-ROM version 1.0, Thieme Verlag Stuttgart 1995.

Finally it is also possible to employ the class of compound of the thermoplastic elastomers (TPE). TPEs can be processed like thermoplastics but have rubber-elastic properties. TPE block polymers, TPE graft polymers, and segmented TPE copolymers comprising two or more monomer units are suitable. Particularly suitable TPEs are thermoplastic polyurethane elastomers (TPE-U or TPU), styrene oligoblock copolymers (TPE-S) such as SBS (styrene-butadiene-styrene-oxy block copolymer) and SEES (styrene-ethylene-butylene-styrene block copolymer, obtainable by hydrogenating SBS), thermoplastic polyolefin elastomers (TPE-O) thermoplastic polyester elastomers (TPE-E) thermoplastic polyamide elastomers (TPE-A), and, in particular, thermoplastic vulcanizates (TPE-V). A person skilled in the art finds details on TPEs in G. Holden et al., Thermoplastic Elastomers, 2nd edition, Hanser Verlag, Munich 1996.

The plastics used in conjunction with the atomized aluminum powder of the invention as a laser marking agent may further comprise customary adjuvants. These adjuvants may be selected, for example, from the group consisting of fillers, additives, plasticizers, lubricants or mold release agents, impact tougheners, color pigments, dyes, flame retardants, antistats, optical brighteners, antioxidants, biostabilizers with antimicrobial activity, chemical blowing agents or organic crosslinking agents, and also other adjuvants or mixtures thereof.

In accordance with one preferred embodiment the fraction of the aluminum particles in the laser-markable and/or laser-weldable plastic is 0.0005% to 0.8% by weight, preferably 0.001% to 0.5% by weight, the amounts being based in each case on the total weight of the plastic.

Surprisingly the advantageous properties of the laser-markable and/or laser-weldable plastic of the invention can be achieved even with very low levels of atomized aluminum powder as laser marking agent. Below 0.0005% by weight of atomized aluminum powder, the advantages according to the invention can be found no longer or only in a very restricted form.

It is preferred, moreover, for the fraction of the aluminum particles in the plastic to be 0.005% to 0.5% by weight, even more preferably 0.01% to 0.2% by weight, based in each case on the total weight of the laser-markable plastic.

From an amount of 0.2% by weight upward, based on the total weight of the plastic, the material may become opaque. In an amount range between 0.05% by weight and 0.2% by weight, the first clouding may occur, and may rise as the concentration goes up to form a grayish coloration of the material. Above 0.8% by weight, the plastic is generally too opaque. Moreover, no further advantage in the quality of laser markability is perceptible. Consequently the use of more laser marking agent would only unnecessarily increase the production costs of the laser-markable plastic.

In an individual case, the amount of atomized aluminum powder in the plastic may be adjusted in dependence on the layer thickness of the material to be marked; in this context, preferably, the amount of atomized aluminum powder can be increased as the layer thickness goes down.

Hence the layer thickness of a film is customarily within a range from 20 μm to about 5 mm. The thickness of injection-molded plastics can amount to up to about 6 cm.

In the case of a film it is possible to increase the amount of atomized aluminum powder in comparison to a plastics molding. In the case of a plastics molding, for example, it is possible to use an amount of 0.005% by weight of spherical aluminum particles, whereas, in the case of a film, an amount of 0.02% by weight of spherical aluminum particles may be suitable. The appropriate amount of atomized aluminum powder may be determined readily by a person skilled in the art on the basis of experiments.

High-contrast marking of a plastic is possible—as will be shown in the examples—even with a concentration of aluminum particle of 0.005% by weight. These concentration figures in % by weight are based in each case on the total weight of the material and of the aluminum particles.

In the case of a layer thickness of the plastic in a range from 20 μm to 500 μm, the fraction of aluminum particles is situated preferably in a range from 0.005% 5 to 0.2% by weight, more preferably from 0.02 to 0.05, based in each case on the total weight of plastic and aluminum particles.

In the case of a layer thickness of the plastic in the range from 500 μm to 2 mm, the fraction of aluminum particles is preferably in a range from 0.001% to 0.1% by weight, more preferably from 0.005 to 0.05, based in each case on the total weight of plastic and aluminum particles.

It has been found, entirely surprisingly, that—as will be shown in the examples—a plastic which comprises aluminum particles with an amount in a range from 0.005% up to 0.05% by weight is completely transparent and at the same time can be marked outstandingly with a laser beam with high contrast. Preference is given to operating in a concentration range from 0.01% to 0.04% by weight of aluminum particles.

The small amount of atomized aluminum powder to be used as laser marking agent affords a number of advantages at once. Thus the materials properties of the plastics material are unaffected, or not substantially affected, by the addition of the atomized aluminum powder of the invention.

In the case of the use of aluminum particles in a range from 0.001% to 0.05% by weight in a transparent or clear plastics material, therefore, there is no deterioration, or no substantial deterioration, in the transparency and/or the color properties of the material doped with the atomized aluminum powder as laser marking agent of the present invention, and yet, surprisingly, high-contrast marking or identification with a laser beam is possible.

Furthermore, the present invention allows the extremely inexpensive provision of a plastics material, since the laser marking agent is produced from inexpensive materials and need only be added in a minor extent to the material to be marked. This is a key economic advantage of the present invention.

The three-dimensional plastics body may also take the form, for example, of a data medium such as a CD, DVD, CD-ROM, etc. On the basis of an abrasion-resistant and unalterable identification, it is possible to tell the original from counterfeits. The three-dimensional plastics body may also, for example, be a blister strip in which drugs are customarily sold in tablet or capsule form. For example, labels or plastics, especially plastics containers, can be provided with a barcode by laser beam.

In further embodiments according to the invention, the laser-markable and/or laser-weldable plastic may be a constituent of an article which itself need not be laser-markable and/or laser-weldable.

Inscription with a standard commercial laser is accomplished by introducing a sample body into the beam path of a laser. The marking obtained is determined by the irradiation time, or pulse number in the case of pulsed lasers, and irradiation power of the laser and also of the plastics system. The power of the lasers used is dependent on the particular application and may be readily determined in each individual case by a person skilled in the art.

Suitable in principle are all customary lasers, examples being gas lasers and solid-state lasers. Gas lasers are, for example (indicated in brackets is the typical wavelength of the radiation emitted):

CO₂ lasers (10.6 μm) argon gas lasers (488 nm and 514.5 nm), helium-neon gas lasers (543 nm, 632.8 nm, 1150 nm), krypton gas lasers (330 to 360 nm, 420 to 800 nm), hydrogen gas lasers (2600 to 3000 nm) and nitrogen gas lasers (337 nm).

Solid-state lasers are, for example (in brackets the typical wavelength of the radiation emitted):

Nd:YAG lasers (Nd³⁺Y₃Al₅O₁₂) (1064 nm), high-performance diode lasers (800 to 1000 nm), ruby lasers (694 nm), F₂ excimer lasers (157 nm), ArF excimer lasers (193 nm) KrCl excimer lasers (222 nm), KrF excimer lasers (248 nm), XeCl excimer lasers (308 nm), XeF excimer lasers (351 nm), and frequency-multiplied Nd:YAG lasers with wavelengths of 532 nm (frequency-doubled), 355 nm (frequency-tripled) or 266 nm (frequency-quadrupled).

Preferred lasers for laser inscribing are the Nd:YAG laser (Nd³⁺Y₃Al₅O₁₂) (1064 nm).

Preferred for laser weldability is the Nd:YAG laser (Nd³⁺Y₃Al₅O₁₂) (1064 nm) and also the high-performance diode laser (800 to 1000 nm), both of which emit in the shortwave infrared.

The lasers used are operated typically at powers of 1 to 400, preferably 5 to 100, and more particularly 10 to 50 watts.

The energy densities of the lasers used are situated in general in the range from 0.3 mJ/cm² to 50 J/cm², preferably 0.3 mJ/cm² to 10 J/cm². In the case of the use of pulsed lasers, the pulse frequency is generally in the range from 1 to 30 kHz. Corresponding lasers which can be used in the present context are available commercially.

One very great advantage of the atomized aluminum powder of the invention is that the wavelength of the laser beam does not have to be set specifically for the atomized aluminum powder. In contrast to metal oxides, metals—hence including aluminum—have a broad absorption capacity, and this is why a very wide variety of lasers with different wavelengths can be used for laser marking a plastic doped with the atomized aluminum powder of the invention.

The prior art sometimes uses metal oxides such as antimony-doped tin oxide as absorber materials. Irrespective of the toxicological risks, these oxides require the use of a defined laser light wavelength in order to effect marking, which complicates handling.

The use of a plastic doped with the atomized aluminum powder of the invention may be in all the fields where customary printing processes have to date been used to inscribe plastics. For example, shaped articles made from plastic doped with the atomized aluminum powder of the invention may find application in the electrical, electronics, and automotive industries. The identification and inscription of, for example, cables, leads, trim strips, and functional parts in the heating, ventilation, and cooling segments, or switches, plugs, levers, and handles made of plastic doped with the atomized aluminum powder of the invention, can be marked with the aid of laser light, even at places which are difficult to access.

Furthermore, plastics systems doped with the atomized aluminum powder of the invention may be employed for packaging in the food segment or in the toy segment. Particular features of the marks on the packs are that they are wipe-resistant and scratch-resistant, are stable in the case of subsequent sterilization operations, and can be applied in a hygienically clean way in the marking operation.

A further important field of application for laser inscription is that of plastic tags for the individual identification of animals, known as cattle tags or ear tags. Via a barcode system, the information specific to the animal is stored. This information can be called up again on demand with the aid of a scanner. The inscription must be very durable, since the ear tags remain on the animals for several years in some cases.

In a further embodiment, the laser marking agent comprising atomized aluminum powder is used in plastics for subsurface laser engraving for the generation of two- or three-dimensional image structures. Subsurface laser engraving processes are described in DE 10 2005 011 180 A1, for example.

The present invention is illustrated by the examples below, though without being restricted thereto.

### INVENTIVE EXAMPLE 1

In an induction crucible furnace (from Induga, furnace capacity around 2.5 tonnes), aluminum bars are continuously introduced and melted. In the forehearth, the aluminum melt, at a temperature of about 720° C., is liquid. A plurality of nozzles which operate in accordance with an injector principle dip into the melt and atomize the aluminum melt vertically upward. The atomizing gas is compressed to 20 bar in compressors (from Kaeser) and heated to up to about 700° C. in gas heaters. The resulting atomized aluminum solidifies and cools in flight. The induction furnace is integrated into a closed plant. Atomization takes place under inert gas (nitrogen). The atomized aluminum powder is deposited first in a cyclone, where the atomized aluminum powder deposited therein has a d₅₀ of 14-17 μm. Further, downstream deposition is served by a multi-cyclone, and the atomized aluminum powder deposited in this has a d₅₀ of 2.3-2.8 μm. Gas/solids separation takes place in a filter (from Alpine) using metal elements (from Pall). In this case, as an ultrafine fraction, an atomized aluminum powder having a d₁₀ of 0.7 μm, a d₅₀ of 1.9 μm, and a d₉₀ of 3.8 μm is obtained.

### INVENTIVE EXAMPLE 2

### Milling

A pot mill (length: 32 cm, width: 19 cm) is charged with 4 kg of glass balls (diameter: 2 mm), 75 g of ultrafine aluminum powder from a), 200 g of white spirit, and 3.75 g of oleic acid. This charge is then milled at 58 rpm for 15 h. The product is separated from the grinding balls by rinsing with white spirit, and then sieved in a wet sieving operation on a 25 μm sieve. The finely particulate material is largely freed from white spirit on a suction filter, and then is pasted up with white spirit in a laboratory mixer (about 50% solids fraction).

This gave an aluminum pigment having an average longitudinal extent, d₅₀, of 13 μm and a thickness distribution, as determined via an SEM count, with characteristic values of h₁₀=35 nm, h₅₀=54 nm, and h₉₀=70 nm.

### INVENTIVE EXAMPLE 3

### Atomized Aluminum Powder

The atomized aluminum powder used was prepared in accordance with inventive example 1. The powder has the following characteristic numbers for its size distribution curve:

D_{10,powder}=0.7 μm; d_{50,powder}=1.6 μm; d_{90,powder}=3.2 μm.

### INVENTIVE EXAMPLE 4

A pot mill (length: 32 cm, width: 19 cm) is charged with 4.7 kg of glass balls (diameter: 2.0 mm), 67 g of ultrafine aluminum powder from inventive example 3, 200 g of white spirit, and 10 g of oleic acid. This charge is then milled at 43 rpm for 22 h. The product is separated from the grinding balls by rinsing with white spirit, and then sieved in a wet sieving operation on a 25 μm sieve. The finely particulate material is largely freed from white spirit on a suction filter, and then is pasted up with white spirit in a laboratory mixer (about 50% solids fraction).

This gave an aluminum pigment having an average longitudinal extent, d₅₀, of 9 μm and a thickness distribution, as determined via an SEM count, with characteristic values of h₁₀=22 nm, h₅₀=32 nm, and h₉₀=43 nm.

### COMPARATIVE EXAMPLE 5

In a procedure based on DE 103 15 775 A1, a pot mill (length: 32 cm, width: 19 cm) is charged with 3.1 kg of glass balls (diameter: 2 mm), 93 g of aluminum powder d_{powder,10}=3.9 μm, d_{powder,50}=6.7 μm, and d_{powder,90}=10.3 μm) 310 g of white spirit, and 3.75 of oleic acid. This charge is then milled at 58 rpm for 15 h. The product is separated from the grinding balls by rinsing with white spirit, and then sieved in a wet sieving operation on a 25 μm sieve. The finely particulate material is largely freed from white spirit on a suction filter, and then is pasted up with white spirit in a laboratory mixer (about 60% solids fraction).

This gave an aluminum pigment having an average longitudinal extent, d₅₀, of 20 μm and a thickness distribution, as determined via an SEM count, with characteristic values of h₁₀=46 nm, h₅₀=74 nm, and h₉₀=145 nm.

### COMPARATIVE EXAMPLE 6

Commercially available Metalure L 55350 (Eckart)

### COMPARATIVE EXAMPLE 7

Commercially available RotoVario 500 080 (Eckart), silver dollar pigment for gravure

### COMPARATIVE EXAMPLE 8

Commercially available RotoVario 042 (Eckart), silver dollar pigment for gravure

Using the pigments of inventive examples 2 and 4 and of comparative examples 5 to 8, reverse-side applications were made using a gravure ink based on a commercially available polyvinyl butyral, by printing a MELINEX 400 film (PET film, 50 μm), on the one hand by means of a coating bar with a channel depth of 24 μm, and on the other hand by means of a printing machine (Rotocolor Rotova 300, 3 ink units; printing speed 100 m/min, viscosity 15 s DIN-4 flow cup; 70 lines/cm; level of pigmentation, depending on particle thickness, between 3.5% (inventive example 6) and 14.5% (inventive example 8)).

The reverse-side applications were characterized optically by a gloss measurement at 60° in a method based on DIN 67 530 (instrument: micro-TRI-gloss from Byk-Gardner, D-82538 Geretsried, Germany) (see table 1). Calibration took place here by means of dark calibration and also by means of a black mirror glass plate with values of 92 for 60°.

The evaluation of the gloss measurement, which took place at 60° in customary fashion, shows that the pigments produced from the atomized aluminum powder of the invention (inventive example 2) have a far higher gloss than conventional pigments from conventional wet milling (see comparative examples 7 and 8).

The visual impression, as well, given by the pigments produced in accordance with inventive examples 2 and 4 is notable for a very strongly metallic mirror effect—similar to that of PVD pigments (see comparative example 6).

The luster of the pigment of the invention in this application corresponds approximately to the luster of PVD pigments (see comparative example 6). Both applications impart a highly metallic mirror effect.

In the case of the aluminum effect pigments produced in accordance with comparative example 5, it was not possible to carry out reverse-side application satisfactorily by printing. The pigments exhibited an inadequate transfer behavior. This metal pigment likewise has an extremely low average thickness, but still has a broader thickness distribution in comparison to inventive examples 2 or 4, and is not suitable for this application.

TABLE 1
Reverse-side application to MELINEX film

| | Reverse-side application | | Reverse-side application | |
|---|---|---|---|---|
| | by printing | | by coating bar | |
| | Gloss | Visual | Gloss | Visual |
| Sample | 60° | impression | 60° | impression |
| Inv. ex. 2 | 643 | very strongly | 619 | very strongly |
| | | metallic, | | metallic, |
| | | “mirror effect” | | “mirror effect” |
| Inv. ex. 4 | 660 | very strongly | 650 | very strongly |
| | | metallic, | | metallic, |
| | | “mirror effect” | | “mirror effect” |
| Comp. ex. 5* | — | — | 504 | metallic |
| Comp. ex. 6 | 677 | very strongly | 672 | very strongly |
| | | metallic, | | metallic, |
| | | “mirror effect” | | “mirror effect” |
| Comp. ex. 7 | 494 | metallic | 445 | metallic |
| Comp. ex. 8 | 339 | metallic, white | 267 | metallic, white |

*This sample could not be applied, since the transfer behavior was inadequate.

### Laser Marking

### INVENTIVE EXAMPLE 9

The inventive powder comprising spherical aluminum particles from inventive example 1 was processed in a mixture with thermoplastic polypropylene (PP) (R 771-10; DOW, Germany, Wesseling) by injection molding to form plates (area 42×60 mm, thickness 2 mm).

To prepare a 1% by weight mixture, the procedure used was as follows:

495 g of polypropylene pellets (PP) and 5 g of the aluminum powder were mixed in a tumble mixer and then processed to pellets in a twin-screw extruder (Bersdorff, Germany, diameter 25 mm, 28 L/D) without addition of further additives at a processing temperature of about 230° C. These pellets were subsequently processed using an injection molding machine (Arburg Allrounder 221-55-250) at the particular processing temperature specific to the material (e.g., PP 260° C.) to give the specimen plaques having the dimensions specified above.

Concentration series were produced in polypropylene with addition of 1.0%, 0.5%, 0.2%, 0.1%, 0.05%, 0.02%, 0.01%, 0.005%, and 0% by weight of spherical aluminum particles, and the plaques obtained in each case were inscribed using an Nd:YAG laser (wavelength: 1064 nm; power: 8 W, pulse frequency: 5 kHz; write speeds: 50-250 mm/s). The figures in % by weight are based on the total weight of aluminum particles and PP.

PP plates without spherical aluminum particles were not markable with the Nd:YAG laser.

When the spherical aluminum particles were used, it was possible, above an amount of 0.005% by weight in PP, to obtain high-contrast, dark and abrasion-resistant marks which exhibited excellent edge definition and dot precision. The PP plates remained transparent and color-neutral.

In the case of an amount of spherical aluminum particles in a range of 0.05-0.5% by weight, increasingly a grayish coloration was found, which accompanied a loss of transparency. PP plates with a spherical aluminum particles content of more than 0.5% by weight were gray-opaque.

No disruptive coarse particles or shards at all were observed. Moreover, even at low concentration ranges (0.005-0.02% by weight), with relatively high write speeds (150-200 nm/s, 8 W, pulse frequency: 5 kHz) of the laser, excellent dot precisions and high contrasts were ensured.

No flow lines or streaks were observed in the PP plates comprising the spherical aluminum particles.

### COMPARATIVE EXAMPLE 10

Spherical aluminum particles having a D₅₀ value of 140 μm and a D₉₀ value of 230 μm (D₉₉ value: not determinable) (determined with the Helos instrument as in example 1) were processed with PP in the same way as inventive example 9.

At quantities above a region of 0.05% by weight of spherical aluminum particles in PP, high-contrast, dark, and abrasion-resistant marks were obtained which exhibited very poor edge definition and dot precision and were therefore inadequate. The PP plates remained transparent and color-neutral. At amounts in a range of 0.2-2.0% by weight of spherical aluminum particles, a grayish coloration was increasingly observed, and was accompanied by a loss of transparency. PP plates with a spherical aluminum particles content of more than 2.0% by weight were gray-opaque. Over the entire concentration range, significant fractions of coarse particles and the significant formation of glittering shards were observed.

### COMPARATIVE EXAMPLE 11

Fine, platelet-like aluminum effect pigments (PC 200, Eckart GmbH & Co. KG, Fürth, Germany) having a D₁₀ value of 1.5 μm, a D₅₀ value of 4.0 μm, and a D₉₀ value of 10.0 μm (determined with the Helos instrument as in inventive example 1) were processed with PP in the same way as in inventive example 9.

At quantities of spherical aluminum particles of ≧0.005% by weight, marks were obtained. In this case the PP plates had a gray clouding even at this level of aluminum effect pigments. In the case of an amount of 0.01% by weight of aluminum effect pigments, the gray clouding was comparable with the gray clouding obtained in inventive example 9 for a level of spherical aluminum particles of ≧0.1% by weight. Even at a pigment content of 0.02% by weight of aluminum effect pigments, the plates were gray-opaque.

The markings were high-contrast, dark and abrasion-resistant, but exhibited reduced dot precision as compared with inventive example 9. The flow lines and streaks typical of products obtained by injection molding using platelet-shaped pigments in the plastics material were observed.

### COMPARATIVE EXAMPLE 12

Antimony-doped tin oxide particles (Mark-It™ pigments, Engelhard Corporation, USA) were processed with PP in accordance with inventive example 9.

The resulting PP plates showed properties comparable with those of the PP plates produced in inventive example 9, but with slightly reduced dot precisions. Instead of the gray coloration obtained in inventive examples 9, 10, and 11, a brownish coloration occurred here at a pigment content of ≧0.1% by weight. The formation of flow lines or streaks was not observed. However, the Mark-It™ pigments used contain highly toxic antimony.

### COMPARATIVE EXAMPLE 13

Mica flakes with antimony-doped tin oxide coating (Lazerflair® 825, E. Merck KGaA, Germany) were processed with PP in accordance with inventive example 9.

The PP plates showed properties comparable with those of the PP plates obtained in inventive example 9. Here, however, the dot precisions observed over all concentration ranges, although good, were reduced by comparison with those of inventive examples 9, 10, and 11; initial clouding occurred at concentrations of ≧0.1% by weight, and the medium became opaque at concentrations of ≧2.0% by weight.

Instead of a gray coloration as obtained for an aluminum particle content of ≧0.1% by weight in inventive example 9, the coloration that occurred here, analogously, with the Lazerflair® 825 pigments, was greenish. In the injection-molded plates, the flow lines and streaks typical when injection-molding plastics materials containing platelet-shaped effect pigment were observed. The Lazerflair® 825 pigment likewise contains toxic antimony.

TABLE 2
Compilation of the results of the laser marking examples

| | | | Markability | Concentrations | Concentrations | Concentrations | Concentrations | | Appearance of |
|---|---|---|---|---|---|---|---|---|---|
| | | | of the | for high- | at which | at which | with loss of | | visible particles |
| | | | polymer | contrast | clouding | coloration | transparency | | (e.g., coarse |
| | | | without | marking | occurs | occurs | (opaque medium) | Dot | particles or |
| Example | Additive | Polymer | addition | [% by wt.] | [% by wt.] | [% by wt.] | [% by wt.] | precision | shards) |
| Inv. | Al powder | PP | not | ≧0.005 | ≧0.05 | ≧0.1 | ≧0.5 | excellent | no |
| ex. 9 | (spherical) | | markable | | | (grayish) | | | |
| Comp. | Al powder | PP | not | ≧0.05 | ≧0.2 | ≧0.5 | ≧2.0 | inadequate | significant |
| ex. 10 | (spherical) | | markable | | | (grayish) | | | |
| Comp. | Al pigment | PP | not | ≧0.005 | ≧0.005 | ≧0.01 | ≧0.02 | good | no |
| ex. 11 | (platelet- | | markable | | | (grayish) | | | |
| | shaped) | | | | | | | | |
| Comp. | Mark-it ™ | PP | not | ≧0.005 | ≧0.05 | ≧0.1 | ≧0.5 | excellent | no |
| ex. 12 | (antimony- | | markable | | | (brownish) | | | |
| | doped tin | | | | | | | | |
| | oxide | | | | | | | | |
| | particles) | | | | | | | | |
| Comp. | Lazerflair ® | PP | not | ≧0.005 | ≧0.1 | ≧0.1 | ≧2.0 | good | no |
| ex. 13 | 825 (mica | | markable | | | (greenish) | | | |
| | flakes with | | | | | | | | |
| | antimony- | | | | | | | | |
| | doped tin | | | | | | | | |
| | oxide | | | | | | | | |
| | coating) | | | | | | | | |

As can be seen from the summarizing table 2, the present invention allows the provision of laser-markable plastics which, by means of the atomized aluminum powder of the invention as a laser marking agent, can be laser-marked transparently and at the same time with very good contrast and high distinctness of image.

A very good high-contrast mark is obtainable generally from a spherical aluminum particles content of or above 0.005% by weight, based on the total weight of the plastics material. Gray coloration or clouding generally occurs at a spherical aluminum particles content at or above 0.05% by weight.

From a comparison with comparative examples 12 and 13 it is evident that the present invention allows the provision of laser-markable plastics without the use of highly toxic antimony-containing compounds or particles.

1. An atomized aluminum powder
wherein
said powder has a particle size distribution with a d₁₀ of 0.15 to 3.0 μm, a d₅₀ of 0.8 to 5.0 μm, and a d₉₀ of 2.0 to 8.0 μm.

2. The atomized aluminum powder of claim 1,
wherein
said powder has a particle size distribution with a d₁₀ of 0.15 to 0.6 μm, a d₅₀ of 0.8 to 2.0 μm, and a d₉₀ of 2.0 to 4.0 μm.

3. The atomized aluminum powder of claim 1,
wherein
said powder has an aluminum content of 99.0% to 99.9% by weight, based on the total weight of said aluminum powder.

4. The atomized aluminum powder of claim 1,
wherein
the atomized aluminum powder particles have a spherical form.

5. A method of producing the atomized aluminum powder of claim 1,
comprising the following steps:
(a) atomizing a liquid aluminum melt, to produce aluminum particles,
(b) collecting the aluminum particles obtained in step (a), to produce atomized aluminum powder, and
(c) classifying the aluminum powder collected in step (b).

6. The method of claim 5,
wherein
the liquid aluminum is atomized under an inert gas atmosphere.

7. The method of claim 5,
wherein
the atomized aluminum powder is classified in the step (c) by at least one of an air classifier and a cyclone.

8. The method of claim 5,
wherein
the atomized aluminum powder before being classified is at least one of mixed with further atomized aluminum powder and homogenized.

9. A method of producing platelet-shaped aluminum pigments, said platelet-shaped aluminum pigments having an average thickness as determined via the thickness count by scanning electron microscopy of 15 to 75 nm, wherein the method comprises producing said pigments from the atomized aluminum powder of claim 1.

10. The method of claim 9, wherein the platelet-shaped aluminum pigments have a relative breadth of thickness distribution, Δh, as determined via a thickness count by scanning electron microscopy, and calculated from the corresponding cumulative undersize curve of the relative frequencies by the formula Δh=100×(h₉₀−h₁₀)/h₅₀, of 30% to less than 70%.

11. A method of laser marking or laser welding a plastic, wherein the method comprises using the atomized aluminum powder of claim 1 as a laser marking agent or laser weldability agent in said plastic.

12. The method of claim 11, wherein the fraction of said powder in said plastic is 0.0005% to 0.8% by weight, based on the total weight of the plastic.

13. The method of claim 11 wherein the powder is used as a laser marking agent for plastic, and wherein the fraction of the aluminum particles in the plastic is 0.005% to 0.5% by weight, based on the total weight of the laser-markable plastic.

14. The method of claim 11 wherein the powder is used as a laser marking agent for plastic,
and wherein
the plastic is a plastic film or a label.

15. The method of claim 14,
wherein
the plastic is a plastic film having a fraction of atomized aluminum powder of 0.01% to 1.0% by weight, based on the total weight of the laser-markable plastic film.

16. The atomized aluminum powder of claim 4, wherein the powder has a spherical form selected from the group consisting of round, ball-like and ellipsoidal forms.

17. The method of claim 6, wherein the inert gas is nitrogen or helium.

18. The method of claim 12, wherein the fraction of said powder in said plastic is 0.001% to 0.5%, by weight, based on the total weight of the plastic.

19. The method of claim 13, wherein the fraction of the aluminum particles in the plastic is 0.01% to 0.1%, by weight, based on the total weight of the laser-markable plastic.

20. The method of claim 15, wherein the fraction of atomized aluminum powder is 0.02% to 0.5%, by weight, based on the total weight of the laser-markable plastic film.
